(19) United States
(12) Patent Application Publication
(10) Pub. No.: US 2015/0170161 A1
(43) Pub. Date: Jun. 18, 2015

(54) SYSTEMS AND METHODS FOR ASSESSING MARKET SATURATION

(71) Applicant: MasterCard International Incorporated, Purchase, NY (US)

(72) Inventors: Kenny Unser, Fairfield, CT (US); Serge Bernard, Danbury, CT (US); Nikhil Malgatti, Stamford, CT (US)

(73) Assignee: MasterCard International Incorporated, Purchase, NY (US)

(21) Appl. No.: 14/104,887

(22) Filed: Dec. 12, 2013

(51) Int. Cl. G06Q 30/02

(52) U.S. Cl. CPC G06Q 30/0201; G06Q 30/0202

(57) ABSTRACT

A system and a computer-implemented method for determining market saturation of industries in selectable geographic regions are provided. The method is implemented using a market saturation computer subsystem in communication with a payment processor, the market saturation computer subsystem coupled to a memory device and the including receiving financial transaction data associated with financial transactions performed in a selectable geographic area, receiving a selection of a subarea of the selectable geographic area, and receiving a selection of one or more comparison subareas. The method also includes comparing the received financial transaction data between one or more industry sectors in each of the selected subareas to the selected subarea of interest, determining a market saturation index for each industry sector within each subarea based on the comparison, and determining, from the market saturation index, whether the subarea of interest is under-served, over-served, or normal for one or more industry sectors.

### BACKGROUND

This disclosure relates generally to assessing a saturation of businesses in a market and, more particularly, to computer systems and computer-based methods for using financial transaction data to compare market saturation of businesses amongst a plurality of geographic areas.

There are many known strategies for locating a new business or expanding a business into a new geographic area or territory. Such strategies generally require collection and processing of large amounts of data by specially trained or experienced personnel. The data is collected from many sources, aggregated for analyses purposes, and then analyzed to determine the market for goods and/or services in the geographic area. In many cases, data subscribed from external sources is expensive and may be inaccurate for the intended purpose or not timely. Further, as used herein, market saturation represents how available goods or services are relative to the population. As such, market saturation changes over time when the local economy changes or the geographic area population shifts in demographics or numbers. Therefore the market saturation determination should be updated periodically to ensure the resultant information remains accurate and timely.

Accordingly, it would be desirable to provide a system and/or method for determining market saturation that relies on an internal data stream that is continuously updated and in a form that requires only a minimum of additional processing.

### BRIEF DESCRIPTION

In one aspect, a computer-implemented method for determining market saturation of industries in selectable geographic regions includes receiving financial transaction data associated with financial transactions performed in a selectable geographic area, receiving a selection of a subarea of the selectable geographic area, and receiving a selection of one or more comparison subareas. The method also includes comparing the received financial transaction data between one or more industry sectors in each of the selected subareas to the selected subarea of interest, determining a market saturation index for each industry sector within each subarea based on the comparison, and determining, from the market saturation index, whether the subarea of interest is under-served, over-served, or normal for one or more industry sectors.

In another aspect, a network-based system for determining market saturation of industries in selectable geographic regions includes a payment network comprising a memory device and a computing device coupled to the memory device, the computing device programmed to receive financial transaction data associated with financial transactions performed in a selectable geographic area, receive a selection of a subarea of interest from the selectable geographic area, and receive a selection of one or more comparison subareas from the selectable geographic area. The computing device is further programmed to compare the received financial transaction data between one or more industry sectors in each of the selected subareas to the selected subarea of interest, determine a market saturation index for each industry sector within each subarea based on the comparison, and determine, from the market saturation index, whether the subarea of interest is under-served, over-served, or normal for one or more industry sectors.

In still another aspect, one or more non-transitory computer-readable storage media has computer-executable instructions embodied thereon that when executed by at least one processor, the computer-executable instructions cause the processor to receive financial transaction data associated with financial transactions performed in a selectable geographic area, receive a selection of a subarea of interest from the selectable geographic area, and receive a selection of one or more comparison subareas from the selectable geographic area. The computer-executable instructions further cause the processor to compare the received financial transaction data between one or more industry sectors in each of the selected subareas to the selected subarea of interest, determine a market saturation index for each industry sector within each subarea based on the comparison, and determine, from the market saturation index, whether the subarea of interest is under-served, over-served, or normal for one or more industry sectors.

### DRAWINGS

FIGS. 1-7 show example embodiments of the methods and systems described herein.

FIG. 1 is a schematic diagram illustrating an example multi-party transaction card industry system for enabling ordinary payment-by-card transactions in which merchants and card issuers do not need to have a one-to-one special relationship.

FIG. 2 is a simplified block diagram of an example processing system including a plurality of computer devices, such as a server system, client systems, a market saturation computer subsystem, and a cardholder computing device.

FIG. 3 is an expanded block diagram of an example embodiment of a server architecture of a processing system including other computer devices in accordance with one embodiment of the present disclosure.

FIG. 4 illustrates an example configuration of a user system operated by a user, such as the cardholder shown in FIG. 1.

FIG. 5 illustrates an example configuration of a server system such as the server system shown in FIGS. 2 and 3.

FIG. 6 is a process flow diagram of the market saturation computer subsystem shown in FIG. 1 in accordance with an example embodiment of the present disclosure.

FIG. 7 is a flow diagram of a method of determining market saturation of industries in selectable geographic regions.

### DETAILED DESCRIPTION

Embodiments of the methods and systems described herein relate to using payment card financial transaction data for assessing market saturation of selected industries in various geographic areas. A market saturation computer subsystem or module that is in communication with a payment card interchange system utilizes transaction data to assess opportunities in geographically defined “markets” by comparing financial transaction activity between markets in each of many business sectors, for example, but not limited to, retail, commodities, dry cleaners, services, gas stations, and others. A market saturation index is assigned to each sector within each market. The market saturation index shows whether the market is under-served, over-served, or normal for each sector. This information can be used by, for example, retailers to identify new store locations and assess a competitive environment in one or more areas. This information can also be used by the commercial real-estate industry to identify the types of merchants that may thrive in a particular location and provide supporting data to the sales process. This information can be used by government entities to facilitate determining what types of businesses a municipality should attract, and by educational institutions to facilitate determining the types of job skills that are needed in the marketplace, and where graduates of particular areas of study should pursue their careers. For example, a chain of appliance stores can find markets where there is little or no competition to build new stores, a service technician can find a market in need of their services and begin advertising their services there, the owner of commercial space can fit their building to attract the types of businesses likely to succeed in the area, a municipality can create incentives to attract businesses needed by the community, and a trade school can design programs geared towards training the professionals needed in the area.

As used herein, “geographic areas” refers to definable area where businesses are located. A geographic area may be defined by contiguous areas having selectable or static boundaries. For example, a defined political subdivision, an industry defined market area, such as, but not limited to a Metropolitan Statistical Area (MSA), or other geographic area with defined boundaries. A political subdivision may be, but not limited to, a county, township, city, village, or library district. Geographic areas may also refer to non-contiguous areas defined by a selectable or predetermined characteristic of the area. For example, a telephone area code no longer represents a contiguous geographic area, but it may still be a useful subdivision for determining certain parameters. Similarly, a geographic subarea may be an established defined area within a geographic area or may be a selectable defined area that is selected based on a current need for the information. For example, if the geographic area is a county, a geographic subarea may be a township.

As used herein, sectors may include, for example but not limited to, a dry cleaners sector, a services sector, and a gas station sector. In various embodiments, the industry sector associated with a business is related to a product or service supplied by the business. As a further example, other industry sectors may include such businesses as professionals, for example, doctors, dentists, accountants, and engineers, restaurants, retail stores, manufacturing, and warehouses.

The methods and systems described herein may be implemented using computer programming or engineering techniques including computer software, firmware, hardware or any combination or subset thereof, wherein the technical effect of the methods and systems may be achieved by performing at least one of the following steps: (a) receiving, by the market saturation computer subsystem, from the payment processor, financial transaction data associated with financial transactions performed in a selectable geographic area; (b) selecting a subarea of interest from the selectable geographic area, where the subarea is a portion of the selectable geographic area; (c) selecting one or more comparison subareas from the selectable geographic area; (d) comparing the received financial transaction data between one or more industry sectors in each of the selected subareas to the selected subarea of interest; (e) determining a market saturation index for each industry sector within each subarea based on the comparison; and (f) determining, from the market saturation index, whether the subarea of interest is under-served, over-served, or normal for one or more industry sectors.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

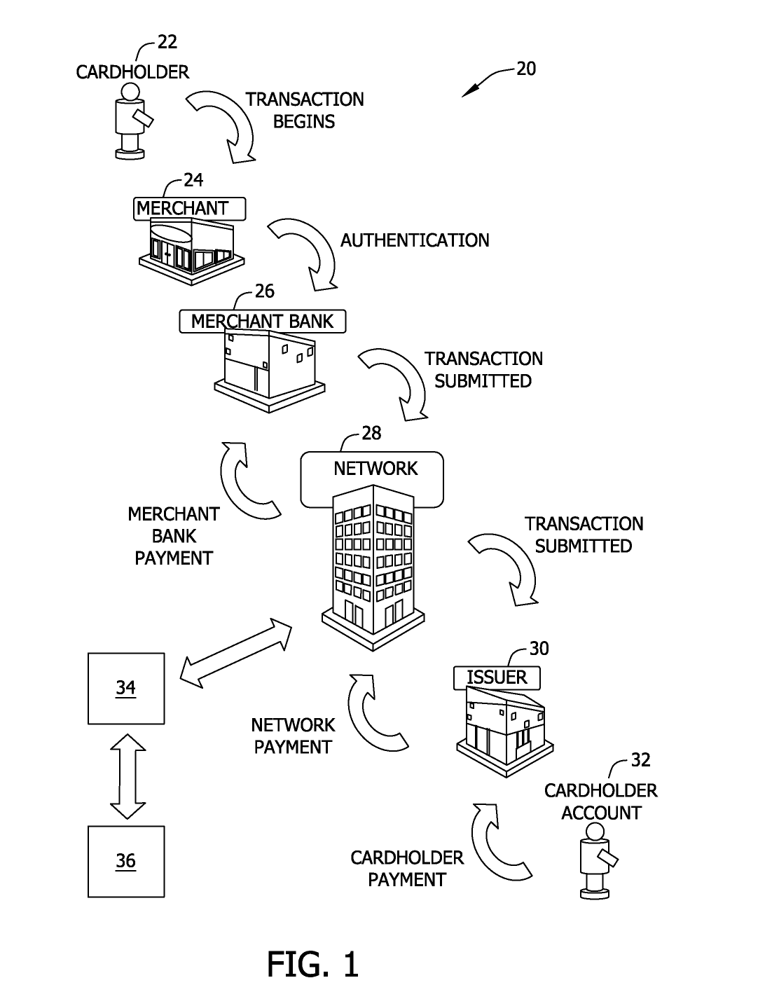

FIG. 1 is a schematic diagram illustrating an example multi-party transaction card industry system 20 for enabling ordinary payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network is a four-party payment card interchange network that includes a plurality of special purpose processors and data structures stored in one or more memory devices communicatively coupled to the processors, and a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

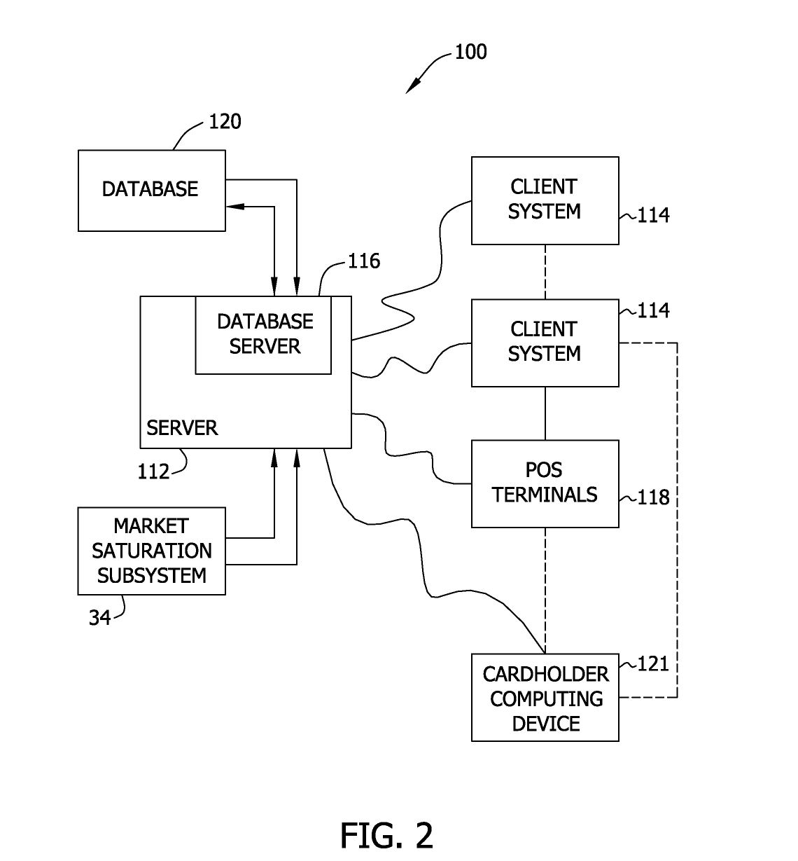

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24. In the example embodiment, a market saturation computer subsystem 34 is communicatively coupled to interchange network 28 and is configured to receive financial transaction data associated with financial transactions performed in a selectable geographic area. Market saturation computer subsystem 34 may determine certain parameters relating to industry sectors in a selectable geographic area and/or other selectable geographic areas, and output those parameters to a user or other computer-based system 36 for further processing.

FIG. 2 is a simplified block diagram of an example processing system 100 including a plurality of computer devices, such as server system 112, client systems 114, market saturation computer subsystem 34, and cardholder computing device 121. In the example embodiment, system 100 may be used for performing payment-by-card transactions and/or determining a market saturation in selectable geographic areas using financial transaction data received as of part processing the financial transaction. For example, system 100 may communicate with market saturation computer subsystem 34 to receive financial transaction data associated with financial transactions performed in a selectable geographic area, a selection of a subarea of interest from the selectable geographic area, and a selection of one or more comparison subareas from the selectable geographic area. Market saturation computer subsystem 34 may compare the received financial transaction data between one or more industry sectors in each of the selected subareas to the selected subarea of interest, determine a market saturation index for each industry sector within each subarea based on the comparison, and determine, from the market saturation index, whether the subarea of interest is under-served, over-served, or normal for one or more industry sectors.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may also store information regarding geographic areas received from data sources external to system 100 and/or interchange network 28 for processing according to the methods described herein.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the example embodiment, server system 112 is associated with a network interchange, such as interchange network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a transaction card, an issuer processor, a remote payment system, a biller, and/or market saturation computer subsystem 34. Market saturation computer subsystem 34 may be associated with interchange network 28 or with an outside third party in a contractual relationship with interchange network 28. Accordingly, each party involved in processing transaction data are associated with a computer system shown in system 100 such that the parties can communicate with one another as described herein.

Using interchange network 28, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

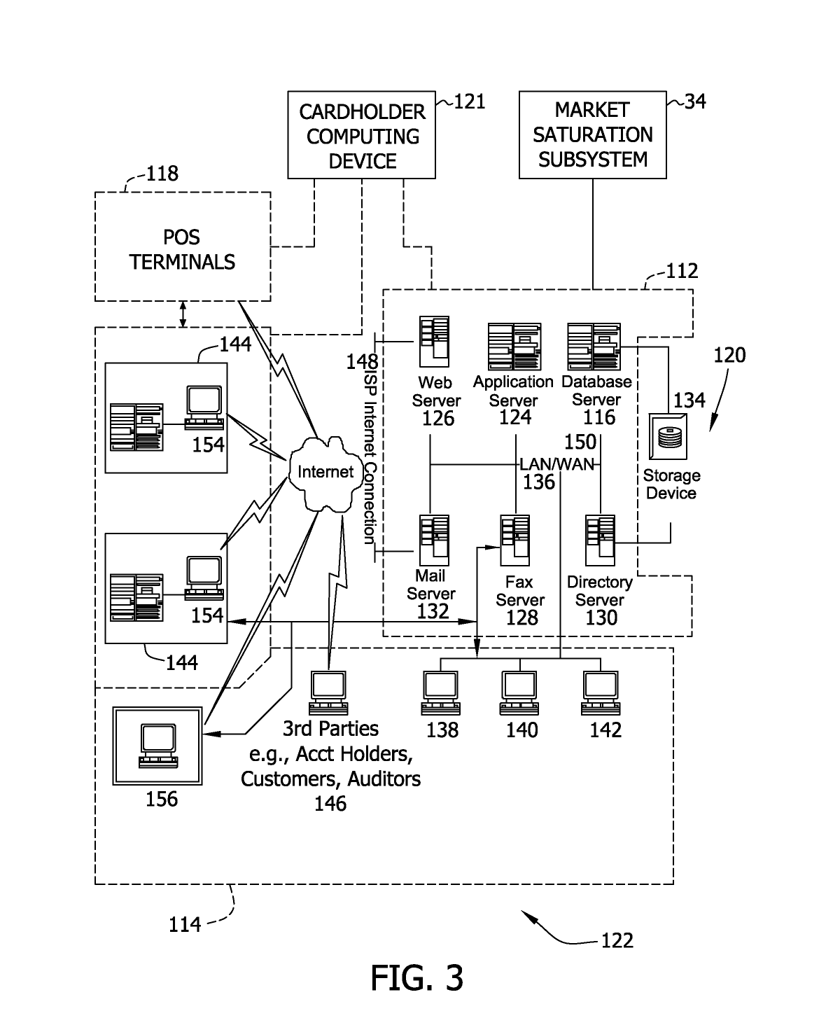

FIG. 3 is an expanded block diagram of an example embodiment of a server architecture of a processing system 122 including other computer devices in accordance with one embodiment of the present disclosure. Components in system 122, identical to components of system 100 (shown in FIG. 2), are identified in FIG. 3 using the same reference numerals as used in FIG. 2. System 122 includes server system 112, client systems 114, market saturation computer subsystem 34, and POS terminals 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

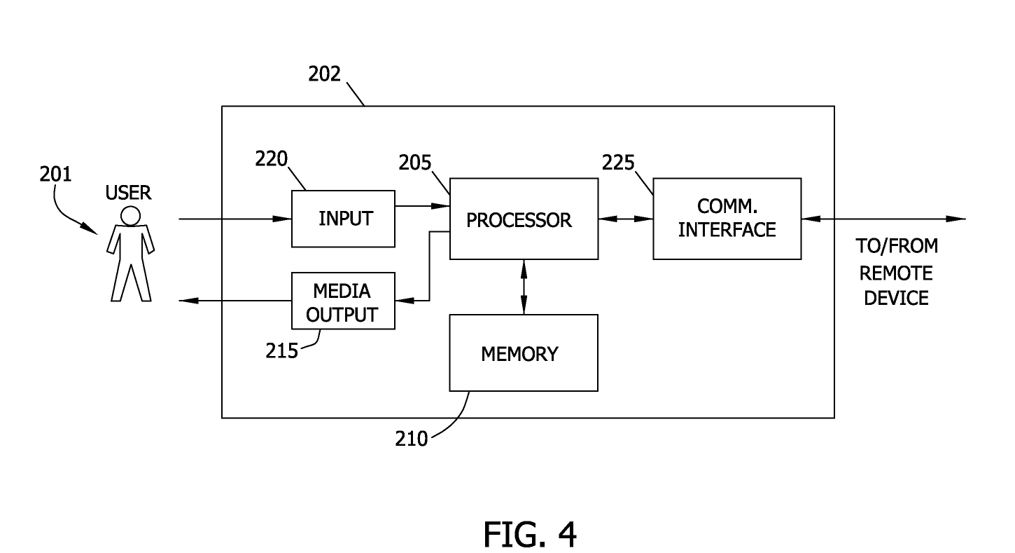

FIG. 4 illustrates an example configuration of a user system 202 operated by a user 201, such as cardholder 22 (shown in FIG. 1). User system 202 may include, but is not limited to, market saturation subsystem 34, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

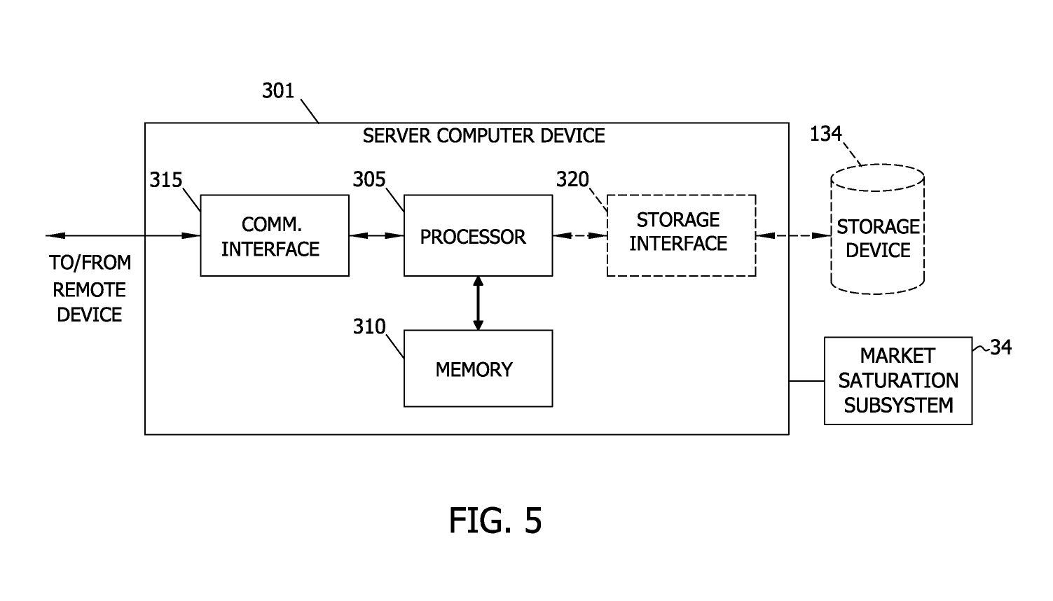

FIG. 5 illustrates an example configuration of a server system 301 such as server system 112 (shown in FIGS. 2 and 3). Server system 301 may include, but is not limited to, database server 116, transaction server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

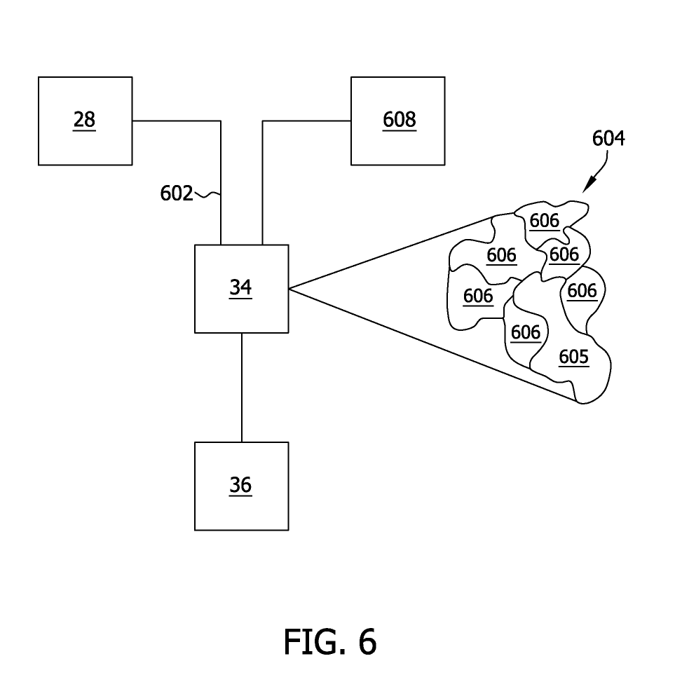

FIG. 6 is a process flow diagram 600 of market saturation computer subsystem 34 in accordance with an example embodiment of the present disclosure. In the example embodiment, market saturation computer subsystem 34 is communicatively coupled to interchange network 28 and configured to receive from interchange network 28, financial transaction data 602 associated with financial transactions performed in a selectable geographic area 604. Selectable geographic area 604 may be one of a plurality of selectable geographic areas (only one selectable geographic area 604 is shown). Market saturation computer subsystem 34 is also configured to receive a selection of a geographic subarea of interest 605 from a plurality of geographic subareas 606 within selectable geographic area 604 and to receive a selection of one or more geographic subareas 606 for comparison to geographic subarea of interest 605. Additionally, market saturation computer subsystem 34 is communicatively coupled to external sources of data 608 that may be used with financial transaction data 602. Alternatively, financial transaction data 602 may be the sole data used by market saturation computer subsystem 34 in determining market saturation. External sources of data 608 may include, for example, but not limited to census data, demographic data, economic reports, labor reports and other data from both public and private sources.

Each of selectable geographic area 604, geographic subarea of interest 605, and plurality of geographic subareas 606 include businesses where financial transactions are currently conducted or may be conducted in the future, for example, when new construction is being considered. When data acquired during the financial transactions is transmitted to interchange network 28, it becomes available to market saturation computer subsystem 34 through interchange network 28. Using financial transaction data 602, market saturation computer subsystem 34 determines industry sectors within selectable geographic area 604 and associates each business in selectable geographic area 604 to generally only one sector of a plurality of sectors. Financial transaction data 602 is also used with, for example, census data from external sources of data 608 to determine a market saturation index for each industry sector in each of plurality of geographic subareas 606. In various embodiments, the market saturation index is determined using statistical methods that relate geographic areas to each other using an industry sector or other comparable parameter that is a part of the respective data. The data includes financial transaction data from interchange network 28 and external data from various sources. For example, the market saturation index may relate a number of auto body shops per capita in one area to a number of auto body shops per capita in any of a number other geographic areas. The result can be normalized for comparison, and the normalized comparison can be output to user 201 or another system for further processing. User 201 may then note via a table, a graph, or other representation of the determined market saturation index whether the selected geographic area is under-served, over-served, or normal for the auto body shop industry sector. Such a market saturation index permits comparison of various geographic areas to quickly discover disparities in representation of industries across geographic areas. The respective market saturation indices may be compared by market saturation computer subsystem 34 to determine which industry sectors in which of the plurality of geographic subareas 606 are under-served, over-served, or normal for one or more industry sectors with respect to each other of plurality of geographic subareas 606. Geographic subarea of interest 605 may be any of plurality of geographic subareas 606 and may be used for a normalized comparison to the other of plurality of geographic subareas 606.

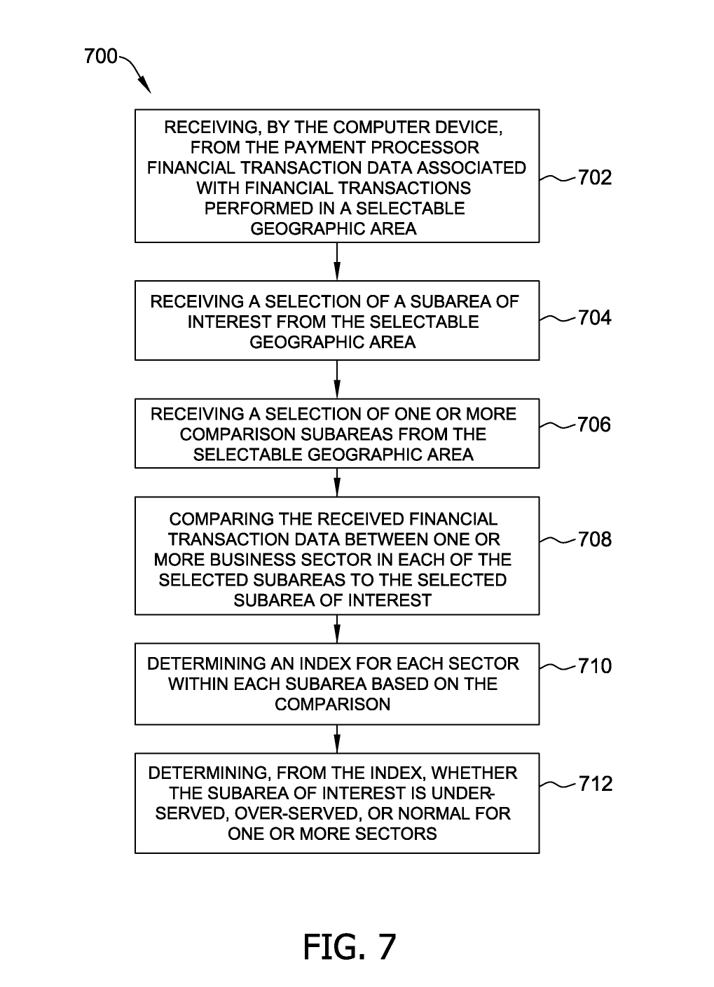

FIG. 7 is a flow diagram of a method 600 of determining market saturation of industries in selectable geographic areas 604 (shown in FIG. 6). In the example embodiment, method 700 includes receiving 702, by the market saturation computer subsystem, from the payment processor, financial transaction data associated with financial transactions performed in a selectable geographic area, receiving 704 a selection of a subarea of interest from the selectable geographic area, and receiving 706 a selection of one or more comparison subareas from the selectable geographic area. Method 700 also includes comparing 708 the received financial transaction data between one or more industry sectors in each of the selected subareas to the selected subarea of interest, determining 710 a market saturation index for each industry sector within each subarea based on the comparison, and determining 712, from the market saturation index, whether the subarea of interest is under-served, over-served, or normal for one or more industry sectors.

In various embodiments, method 700 optionally includes receiving data for the selectable geographic area from a data source external to the payment processor. Such data may include demographic data, census data, bureau of labor statistics, and/or business data for one or more selectable geographic areas. Method 700 may include comparing the received financial transaction data between one or more industry sectors, which may include, for example, but, not limited to, a dry cleaners sector, a services sector, and a gas station sector. In various embodiments, the industry sector associated with a business is related to a product or service supplied by the business. As a further example, other industry sectors may include such businesses as professionals, for example, doctors, dentists, accountants, and engineers, restaurants, retail stores, manufacturing, and warehouses.

Method 700 may also include selecting a subarea that defines a market for goods and services provided by merchants divided into industry sectors. Optionally, method 700 may also include determining a market saturation index for each industry sector, the industry sectors each represent a type of business in which the merchant is engaged. The market saturation index represents a statistical analysis of the financial transaction data and/or the received data from the external source. The market saturation index may also be compared to predetermined threshold range to determine whether the subarea of interest is under-served, over-served, or normal for one or more sectors. Because the market saturation indices are expected to change over time due to changes in population, businesses moving into or out of geographic areas, and changes in an economic condition of the geographic area, it is important for market saturation computer subsystem 34 to be able to determine a time series of market saturation indices that can be compared over a predetermined time period or a time period selectable by, for example, user 201. For example, during an economic downturn for a geographic area, it would be expected that higher-end retailers may leave the geographic area and discount retailers would move in to fill the market void for retailers. Monitoring market saturation indices over time may provide information that would allow a retailer to enter a market sooner and become more established before the retailer's competitors enter the same market.

In an example, a geographic area 604 may be selected from a plurality of available geographic areas. Geographic area 604 may be defined by being within the boundaries of, for example, but not limited to, a zip code, area code, or a governmentally designated area. Geographic area 604 may include a plurality of subareas 606 and one or more of subareas 606 may be defined as a subarea of interest 605. Subarea of interest 605 may be any portion of geographic area 604, including, for example, but not limited to a neighborhood. User 201 may be interested in locating a business within boundaries of geographic area 604, but may not know where the best location would be. It is generally desirous to locate the business in an area that is underserved for that type of business. User 201 can select a geographic area 604, any number of subareas 606, and any number of industry sectors for analysis. Market saturation computer subsystem 34 may then communicate with interchange network 28 to request and receive financial transaction data 602 associated with financial transactions performed in selected geographic area 604. Additionally, and optionally, market saturation computer subsystem 34 may request and receive additional data, such as, but not limited to census data for selected geographic area 604 from external sources of data 608.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processors 205, 305, including RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any of computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

The above-described embodiments of a method and system of assessing market saturation in one or more geographic areas provides a cost-effective and reliable means for determining whether an industry sector in a geographic area is saturated, where an industry sector in a geographic area is saturated when the population has more of the type of businesses that are categorized in the industry sector than peer geographic areas. More specifically, the methods and systems described herein facilitate using readily available and properly formatted data to continuously and automatically to determine market saturation in selected geographic areas. In addition, the above-described methods and systems facilitate monitoring a change in market saturation in a geographic area over time. As a result, the methods and systems described herein facilitate businesses making sound relocation decisions in a cost-effective and reliable manner.

This written description uses examples to describe various embodiments of the disclosure, including the best mode, and also to enable any person skilled in the art to practice the embodiments, including making and using any devices or systems and performing any incorporated methods. The patentable scope of the application is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for determining market saturation of industries in selectable geographic regions, the method implemented using a market saturation computer subsystem in communication with a payment processor, the market saturation computer subsystem coupled to a memory device, the method comprising:
receiving, by the market saturation computer subsystem, from the payment processor, financial transaction data associated with financial transactions performed in a selectable geographic area;
receiving a selection of a subarea of interest from the selectable geographic area;
receiving a selection of one or more comparison subareas from the selectable geographic area;
comparing the received financial transaction data between one or more industry sectors in each of the selected subareas to the selected subarea of interest;
determining a market saturation index for each industry sector within each subarea based on the comparison; and
determining, from the market saturation index, whether the subarea of interest is under-served, over-served, or normal for one or more industry sectors.

2. The computer-based method of claim 1, further comprising receiving data for the selectable geographic area from a data source external to the payment processor.

3. The computer-based method of claim 1, further comprising receiving demographic data for the selectable geographic area from a data source external to the payment processor.

4. The computer-based method of claim 1, wherein comparing the received financial transaction data between one or more industry sectors in each of the selected subareas to the selected subarea of interest comprises comparing the received financial transaction data between one or more of a retail sector, a services sector, and a commodities sector.

5. The computer-based method of claim 1, wherein receiving a selection of a subarea of interest from the selectable geographic area comprises selecting a subarea that defines a market for goods and services provided by merchants divided into industry sectors.

6. The computer-based method of claim 1, wherein determining a market saturation index for each industry sector within each subarea based on the comparison comprises determining a market saturation index for each industry sector, the industry sectors each representing a type of business in which the merchant is engaged.

7. The computer-based method of claim 1, wherein determining a market saturation index for each industry sector within each subarea based on the comparison comprises determining a market saturation index for each industry sector, the market saturation index representing a statistical analysis of the financial transaction data and the received data from the external source.

8. The computer-based method of claim 1, further comprising comparing the determined market saturation index to predetermined threshold range to determine whether the subarea of interest is under-served, over-served, or normal for one or more sectors.

9. The computer-based method of claim 1, further comprising outputting a representation of the determined market saturation index for at least one of a subarea and a sector.

10. The computer-based method of claim 1, further comprising determining a change of one or more of the market saturation indices over at least one of a predetermined time period and a time period selectable by a user.

11. The computer-based method of claim 10, further comprising displaying a time series of the one or more market saturation indices determined over at least one of a selectable time period and a selectable duration.

12. A network-based system for determining market saturation of industries in selectable geographic regions, said network-based system comprising:
a payment network comprising a memory device and a computing device coupled to the memory device, the computing device programmed to:
receive financial transaction data associated with financial transactions performed in a selectable geographic area;
receive a selection of a subarea of interest from the selectable geographic area;
receive a selection of one or more comparison subareas from the selectable geographic area;
compare the received financial transaction data between one or more industry sectors in each of the selected subareas to the selected subarea of interest;
determine a market saturation index for each industry sector within each subarea based on the comparison; and
determine, from the market saturation index, whether the subarea of interest is under-served, over-served, or normal for one or more industry sectors.

13. The network-based system of claim 12, wherein said computing device is programmed to determine one or more of the market saturation indices over time and display a time series of the one or more market saturation indices determined over at least one of a selectable time period and a selectable duration.

14. The network-based system of claim 12, wherein said computing device is programmed to receive demographic data for the selectable geographic area from a data source external to the payment network.

15. The network-based system of claim 12, wherein said computing device is programmed to compare the received financial transaction data between one or more of a retail sector, a services sector, and an automotive sector.

16. The network-based system of claim 12, wherein said computing device is programmed to select a subarea that defines a market for goods and services provided by merchants divided into industry sectors.

17. One or more non-transitory computer-readable storage media having computer-executable instructions embodied thereon, wherein when executed by at least one processor, the computer-executable instructions cause the processor to:
receive financial transaction data associated with financial transactions performed in a selectable geographic area;
receive a selection of a subarea of interest from the selectable geographic area;
receive a selection of one or more comparison subareas from the selectable geographic area;
compare the received financial transaction data between one or more industry sectors in each of the selected subareas to the selected subarea of interest;
determine a market saturation index for each industry sector within each subarea based on the comparison; and
determine, from the market saturation index, whether the subarea of interest is under-served, over-served, or normal for one or more industry sectors.

18. The computer-readable storage media of claim 17, wherein the computer-executable instructions further cause the processor to determine a market saturation index for each industry sector, the industry sectors each represent a type of business in which the merchant is engaged.

19. The computer-readable storage media of claim 17, wherein the computer-executable instructions further cause the processor to determine a market saturation index for each industry sector, the market saturation index representing a statistical analysis of the financial transaction data and the received data from the external source.

20. The computer-readable storage media of claim 17, wherein the computer-executable instructions further cause the processor to compare the determined market saturation index to predetermined threshold range to determine whether the subarea of interest is under-served, over-served, or normal for one or more sectors.
